(19) United States
(12) Patent Application Publication
(10) Pub. No.: US 2024/0074010 A1
(43) Pub. Date: Feb. 29, 2024

(54) SPLATTER-REDUCING DEVICE FOR MICROWAVE INTERIORS

(71) Applicant: THE MICRO-SHEETS COMPANY, Vista, CA (US)

(72) Inventors: Martin KEEN, VISTA, CA (US); Ian LAITY, IRVINE, CA (US)

(21) Appl. No.: 18/230,598

(22) Filed: Aug. 4, 2023

Related U.S. Application Data
(60) Provisional application No. 63/373,923, filed on Aug. 30, 2022.

(51) Int. Cl. H05B 6/64

(52) U.S. Cl. CPC H05B 6/6408

(57) ABSTRACT

Devices disclosed herein reduce splattering of food/beverage material on interior cooking appliance surfaces. A splatter-reducing device of the present technology may comprise: (1) a magnetic member magnetically coupled to an interior ceiling surface of a cooking appliance, the magnetic member comprising a magnet and a first coupling component affixed to a bottom surface of the magnet; (2) a support frame comprising a second coupling component removably coupled to the first coupling component such that the support frame is suspended within the cooking appliance; and (3) a splatter-reducing shroud supported by the support frame and shaped to enclose a central region for placing food or liquid heated within the cooking appliance. The splatter-reducing shroud (e.g., a disposable or washable material such as absorbent paper) may absorb or deflect ejected food or beverage material before the material can splatter on an interior surface of the cooking appliance.

### CROSS-REFERENCE TO RELATED APPLICATIONS

This present application claims priority to U.S. Provisional Patent Application No. 63/373,923 filed Aug. 20, 2022 and titled “MICRO-SHEETS,” the contents of which are hereby incorporated herein by reference in their entirety.

### BACKGROUND

Microwave ovens have become an integral part of modern kitchens due to their efficiency and convenience for heating food. However, a longstanding issue associated with the use of microwave ovens is the tendency for food to splatter within the interior during the cooking process, which can lead to unhygienic conditions and reduced appliance longevity. Microwave ovens heat food by exposing it to electromagnetic radiation at microwave frequencies, i.e., roughly 1 GHz to 1000 GHz. This electromagnetic radiation may pass through or reflect off metal, glass, or plastic surfaces in the microwave oven before being absorbed by and heating the food.

### BRIEF DESCRIPTION OF THE DRAWINGS

The present disclosure, in accordance with one or more various examples, is described in detail with reference to the following figures. The figures are provided for purposes of illustration only and merely depict examples.

FIG. 1 illustrates a perspective view of an example splatter-reducing device located within a cooking appliance, in accordance with examples disclosed herein.

FIGS. 2A-C illustrate various aspects of an example splatter-reducing shroud, in accordance with examples disclosed herein.

FIGS. 3A-C illustrate various aspects of an example support frame supporting a splatter-reducing shroud, in accordance with examples disclosed herein.

FIGS. 4A-D illustrate various aspects of an example magnetic member, in accordance with examples disclosed herein.

FIGS. 5A-C illustrate various aspects of example magnetic members and the magnetic members' removable coupling to a support frame, in accordance with examples disclosed herein.

FIGS. 6A-C illustrate additional aspects of example magnetic members and the magnetic members' removable coupling to a support frame, in accordance with examples disclosed herein

FIG. 7 illustrates several example splatter-reducing flooring sizes and shapes, in accordance with examples disclosed herein

The figures are not exhaustive and do not limit the present disclosure to the precise form disclosed.

### DETAILED DESCRIPTION

Rapid heating of food or beverage items in a cooking appliance can result in splattering of food or beverage material on the interior surfaces of a cooking appliance (e.g., a microwave oven or similar cooking appliance used for heating food and beverage). This may occur when fluid is trapped within a food or beverage item undergoing heating in the cooking appliance. Raising the temperature of the fluid can cause pressure to build until the food or beverage item ruptures, rapidly expelling the contained food or beverage material out onto interior surfaces of the cooking appliance.

This issue is accentuated in the context of microwave ovens, where the use of electromagnetic radiation to heat food may result in faster cooking times and a more violent splattering of food. Splattered food or beverage material on the interior surfaces of a microwave ovens can appear unsightly, contaminate other food or beverage items, present a fire hazard, or damage waveguide covers within the microwave oven.

Devices disclosed herein reduce the splattering of food or beverage material on interior cooking appliance surfaces. A splatter-reducing device of the presently disclosed technology may comprise: (1) a magnetic member magnetically coupled to an interior ceiling surface of a cooking appliance, the magnetic member comprising a magnet and a first coupling component affixed to a bottom surface of the magnet; (2) a support frame comprising a second coupling component removably coupled to the first coupling component such that the support frame is suspended within the cooking appliance; and (3) a splatter-reducing shroud supported by the support frame and shaped to enclose a central region for placing food or liquid to be heated within the cooking appliance. The splatter-reducing shroud (e.g., a disposable or washable material such as absorbent paper) may absorb or deflect ejected food or beverage material before the material can splatter on an interior surface of the cooking appliance. In some examples, a splatter-reducing flooring is included to rest on top of an interior flooring surface of the cooking appliance, such that splattered or leaked food or beverage material is absorbed by the splatter-reducing flooring.

The disclosed devices enable novel methods of maintaining a clean cooking appliance interior. One such novel method may involve removing the splatter-reducing device (or in some cases, just the splatter-reducing shroud and flooring) from the cooking appliance after the splatter-reducing shroud and flooring have absorbed splattered food or beverage material. After removal, the splatter-reducing device may be cleaned or replaced with a new splatter-reducing device (or in some cases, only the splatter-reducing shroud and flooring may be replaced/cleaned while the support frame and magnetic member are reused). Relatedly, components of the splatter-reducing device (e.g., the splatter-reducing shroud, the splatter-reducing flooring, etc.) may be separated from other components of the splatter-reducing device (e.g., the support frame and magnetic member) to enable separate cleaning or replacement of the splatter-reducing device's components. Previous methods of maintaining clean cooking appliance interiors may have required, for instance, repeated reaching into the cooking appliance to scrub interior surfaces. Cleaning or replacement of a splatter-reducing device, and/or its individual components (e.g., the splatter-reducing shroud), may mitigate the need to employ such previous methods. Relatedly, through suspension from a cooking appliance ceiling, a splatter-reducing device of the presently disclosed technology may be easier to manipulate for users than a potential alternative device which is not suspended from the cooking appliance ceiling (e.g., a device that is placed over food/beverage material and rests on the floor of the cooking appliance when in use). For example, it may be easier for users to slide food or beverage underneath the suspended splatter-reducing device of the presently disclosed technology (in some cases this may also involve lifting a cooking appliance door-facing flap of the shroud to permit the food or beverage item to slide under the suspended splatter-reducing device) than for users to lift and place the potential alternative device over the food or beverage material when both items are within the cooking appliance. Here, the greater convenience of the suspended splatter-reducing device of the presently disclosed technology can lead to increased usage over potential alternative designs—resulting in improved splatter mitigation, especially in office-type environments with a varied user base.

As alluded to above, the magnetic member may comprise a magnet and a coupling component (e.g., a hook, a loop, a flanged terminus that can be received by a slotted groove of the support frame, etc.). The magnetic member may magnetically couple to the interior ceiling surface of the cooking appliance by magnetic attraction between the magnet and the interior ceiling surface. In certain examples, the magnetic member may further comprise an insulating material covering at least a portion of the magnet. Where the cooking appliance is a microwave oven, insulating the magnet can mitigate interference between the magnet and energy emitted by operation of the microwave oven. In some examples, the insulating material may be magnetically insulating and cover multiple surfaces of the magnet, except, e.g., a surface of the magnet facing an interior ceiling surface of the cooking appliance. In some examples, the insulating material may comprise electrical or thermal insulation. In certain examples, the insulating material may comprise electromagnetic shielding. In some examples, the insulating material may comprise a composite of multiple different types of shielding or insulation.

In some examples, the insulating material may be omitted entirely. Contrary to a common misconception, presence of permanent magnets (including neodymium magnets) within a microwave oven along with food or beverage items has not been shown to appreciably degrade the magnets or operation of the microwave. Where sufficient food or beverage material is present along with the magnet, the magnet may stay below temperatures which cause degradation of the magnet's strength due to heat. Nevertheless, including insulating material may still have a purpose. For example, the insulating material may mitigate interference with magnetic materials not yet tested in microwaves, protect magnets from other non-microwave operation related factors (e.g., moisture in the air), etc.

As alluded to above, the support frame may couple to the magnetic member such that such that the support frame is suspended within the cooking appliance. In turn, the support frame can support the splatter-reducing shroud such that the splatter-reducing shroud is also suspended within the cooking appliance. In various examples, the support frame may have an approximately planar construction and may be suspended within the cooking appliance approximately parallel (e.g., within 10 degrees of parallel) to the floor surface of the cooking appliance. In various examples, the support frame may comprise a plastic material.

As alluded to above, the support frame may comprise a coupling component (e.g., a loop, a hook, a slotted groove that receives a flanged terminus of the magnetic member, etc.) that removably couples with a coupling component of the magnetic member. Where the coupling component of the support frame is a slotted grove, the slotted groove may receive a flanged terminus of the magnetic member at a first end of the slotted groove and guide the flanged terminus to a removably fixed position at a second end of the slotted groove.

In some examples, the coupling component of the support frame may comprise a hook and the coupling component of the magnetic member may comprise a loop (or vice versa). In some examples, respective coupling components of the magnetic member and support frame may comprise other features matched to provide mechanical coupling, e.g., a socket and a stud fastener.

In some examples, the splatter-reducing device may comprise multiple magnetic members—for example a first magnetic member and a second magnetic member. In these examples, respective coupling components of the first and second magnetic members may comprise hooks or loops. The splatter-reducing device may further comprise a rod that is removably positioned through the loops/hooks of the first and second magnetic members such that the rod is supported by the loops/hooks of the first and second magnetic members. Further, the coupling component of the support frame may be a hook that removably couples to the rod such that the support frame suspends below the rod. In certain examples, the rod may comprise anti-sliding ridges that inhibit the hook of the support frame from sliding along the rod.

In some examples, the coupling component of the magnetic member may couple with a coupling component located at the approximate center of the support frame. In such examples the magnetic member may magnetically couple with an accessible or magnetically active region of the interior ceiling surface of the cooking appliance to suspend the support frame within the cooking appliance.

In some examples, a coupling component of a first magnetic member may couple with a first coupling component of the support frame located at first position of the support frame, while a coupling component of a second magnetic member couples with a second coupling component of the support frame located at second position of the support frame. Here, the first and second positions may be on opposing halves of a surface of the support frame. In such examples, the first and second magnetic members may magnetically couple with an interior ceiling surface of the cooking appliance to provide multiple suspension points for the support frame, resulting in a stable suspension of the support frame within the cooking appliance.

As alluded to above, the splatter-reducing shroud may be supported by the support frame and may be shaped to enclose a central region for placing food or liquid to be heated within the cooking appliance. In various examples, the splatter-reducing shroud may comprise an absorbent paper material. In some examples, the absorbent paper material may be washed and reused.

In various examples, the splatter-reducing shroud may comprise a support frame pocket, within which the support frame may be slidably inserted. After insertion into the support frame pocket, the support frame may be mechanically coupled with the magnetic member, and the magnetic member may be magnetically coupled to a cooking appliance ceiling. The support frame may then suspend the splatter-reducing shroud within the cooking appliance such that the splatter-reducing shroud encloses a central region for placing food or liquid to be heated within the cooking appliance. In these examples, the splatter-reducing shroud may be removed for replacement or cleaning by decoupling the support frame from the magnetic member, and then removing the support frame from the support frame pocket. In certain examples, the entire splatter-reducing device may be removed from the cooking appliance by decoupling the magnetic member from the interior ceiling surface of the cooking appliance.

In some examples the splatter-reducing shroud may comprise a top member and four hanging flaps adjoined to four respective edges of the top member. In certain examples, the top member may comprise a top sub-member and a bottom sub-member adjoined at (or proximate to) opposing edges (e.g., edges facing the left and right surfaces of a cooking appliance) to form the support frame pocket. As alluded to above, the support frame pocket can effectively sandwich the support frame when the support frame is slidably inserted into the support frame pocket. Here, the top sub-member and two of the flaps (e.g., the two flaps facing the left and right surfaces of the cooking appliance) may comprise a first continuous piece of material and the bottom sub-member and the other two flaps (e.g., the two flaps facing the cooking appliance door and back surface of the cooking appliance) may comprise a second continuous piece of material. The first and second continuous pieces of material may be adjoined e.g., via adhesive interfaces proximate to opposing edges of the top/bottom sub-members.

In some examples, the top sub-member may comprise a lift tab at a cooking appliance door-facing edge of the top sub-member. Pulling the lift tab may further open the support frame pocket to facilitate slidable insertion or removal of the support frame within the support frame pocket.

In some examples, the top sub-member may comprise one or more openings through which coupling component(s) of the support frame may couple with reciprocal coupling component(s) of magnetic member(s).

In some examples, the support frame may comprise ventilation holes and some portion of the splatter-reducing shroud may be air-permeable, such that when the support frame is inserted within the splatter-reducing shroud, air flow is permitted through the support frame. Such permission of air flow may mitigate obstruction of ventilation systems of the cooking appliance.

In some examples, an interior flooring surface of the cooking appliance (e.g., an interior ceiling-facing surface, a fixed platter, a turntable platter) may be covered by a splatter-reducing flooring, such that the splatter-reducing flooring is located between a food or beverage item and the interior flooring surface. The splatter-reducing flooring may be made from the same materials comprising the splatter-reducing shroud. The splatter-reducing flooring may be connected to the splatter-reducing shroud, or may be a separately placed component of the splatter-reducing device. The splatter-reducing shroud may be sized to match the interior flooring surface, or to match an area outlined by edges of the splatter-reducing shroud.

In some examples, e.g., wherein the interior ceiling surface of the cooking appliance comprises non-magnetic material, the magnetic member may be omitted. Instead, the support frame may be mechanically coupled to a fixable member, wherein the fixable member is mechanically coupled, e.g., by way of an adhesive connection, to the ceiling surface of the cooking appliance.

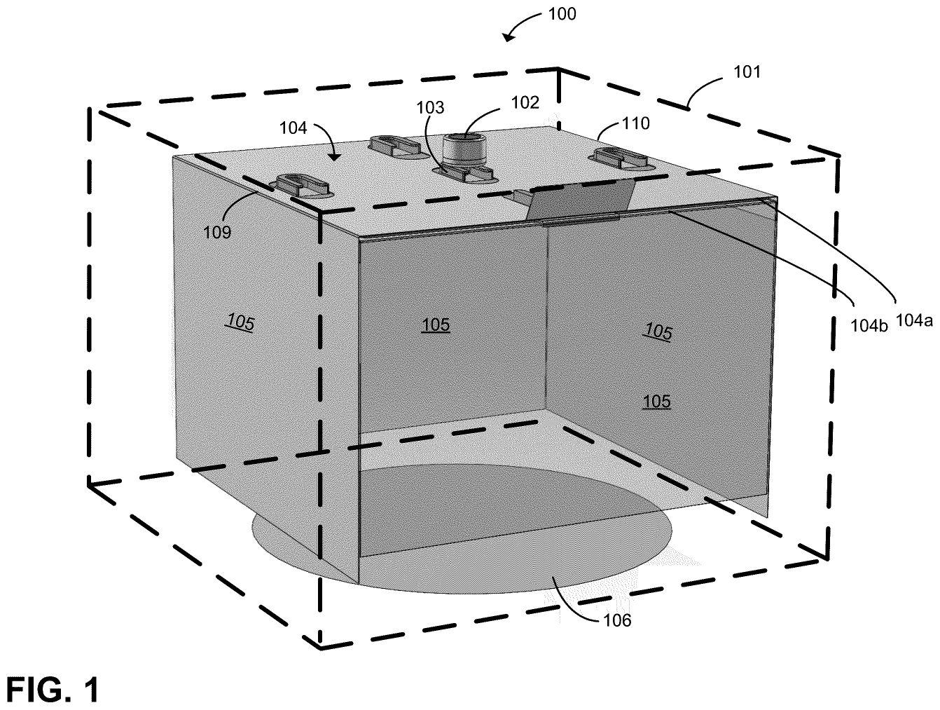

FIG. 1 illustrates a perspective view of an example splatter-reducing device 100 located within a cooking appliance 101, in accordance with examples disclosed herein. Cooking appliance 101 is illustrated via dotted lines outlining the interior surfaces of cooking appliance 101. Cooking appliance 101 (e.g., a microwave oven) is an example environment within which splatter-reducing device 100 may be implemented. Splatter-reducing device 100 comprises: (1) a magnetic member 102; (2) a support frame 103; (3) a splatter-reducing shroud comprising a top member 104 (in turn comprising a top sub-member 104a and a bottom sub-member 104b) and four flaps 105; and (4) a splatter-reducing flooring 106.

Splatter-reducing device 100 may be implemented within cooking appliance 101 by magnetically coupling magnetic member 102 to an internal ceiling surface of cooking appliance 101. Magnetic member 102 may be mechanically coupled to support frame 103. Support frame 103 may be inserted within a support frame pocket formed by top sub-member 104a and bottom sub-member 104b of the splatter-reducing shroud. For example, top sub-member 104a and bottom sub-member 104b may be adjoined at (or proximate to) opposing edges 109 and 110 to form the support frame pocket. The four flaps 105 may be adjoined/affixed to the four respective edges of top member 104 (here, at least the front cooking appliance door-facing flap may be adjoined to bottom sub-member 104b to permit support frame 103's insertion into the support frame pocket formed by top sub-member 104a and bottom sub-member 104b) such that the four flaps 105 hang down/suspend from top member 104 to enclose a central region for placing food or liquid to be heated within cooking appliance 101. Splatter-reducing flooring 106 may be laid on a ceiling-facing interior surface of cooking appliance 101 (e.g., the rotatable cooking top of a microwave oven), such that the splatter-reducing flooring 106 is located between the cooking volume and the ceiling-facing interior surface of cooking appliance 101. In some examples, splatter-reducing flooring 106 may be coupled with the splatter-reducing shroud. In some examples, splatter-reducing flooring 106 may be omitted.

As alluded to above, the four flaps 105 may be adjoined to the four respective edges of top sub-member 104 e.g., by an adhesive strip or as continuous pieces (as alluded to above, at least a front cooking appliance door-facing flap may be adjoined to bottom sub-member 104b instead of top sub-member 104a to permit support frame 103's insertion into the support frame pocket formed by top sub-member 104a and bottom sub-member 104b). Here, such adjoining may permit the flaps 105 to be lifted. Lifting flaps 105 may provide access to the cooking volume, such that an operator of the cooking appliance may insert or remove a food or beverage item. Once a food or beverage item is inserted in the cooking volume, the food or beverage item may be heated by cooking appliance 101. Food or beverage material ejected during heating of the food or beverage item may be absorbed or deflected by the splatter-reducing shroud (i.e., the four flaps 105 and top member 104) or splatter-reducing flooring 106. The absorption or deflection of ejected food or beverage material may prevent the ejected food or beverage material from splattering on the interior surfaces of cooking appliance 101.

Further, support frame 103 may be decoupled from magnetic member 102 and removed from the support frame pocket of the splatter-reducing shroud to allow the splatter-reducing shroud to be cleaned or replaced by a new splatter-reducing shroud. Removal and replacement, or removal and cleaning of the splatter-reducing shroud may be more convenient than cleaning the interior surfaces of cooking appliance 101 via existing methods (e.g., scrubbing the interior surfaces of cooking appliance 101). As such, splatter-reducing device 100 can mitigate operator reluctance in removing splattered food or beverage items from cooking appliance 101, resulting in more frequent removal of splattered food or beverage items from cooking appliance 101.

Flaps 105 are depicted herein as transparent for purposes of illustrating the bounds of the cooking volume enclosed by the splatter-reducing shroud. In some examples, flaps 105 may actually be transparent. In other examples, flaps 105 and top member 104 may have any opacity.

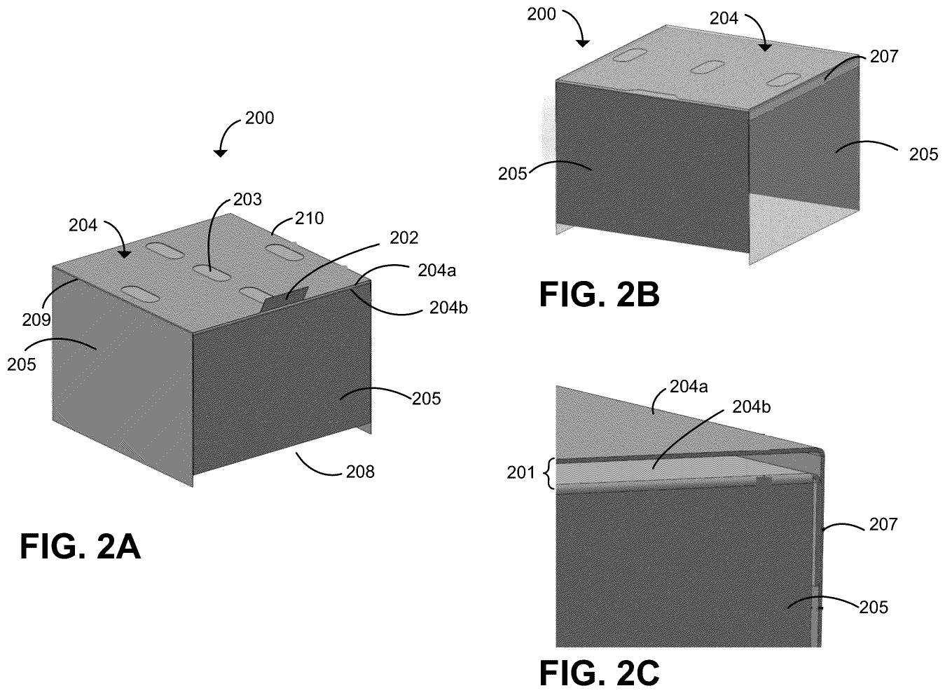

FIGS. 2A-C illustrate various aspects of an example splatter-reducing shroud 200, in accordance with examples disclosed herein.

As depicted, splatter-reducing shroud 200 comprises a top member 204 and flaps 205. Top member 204 comprises a top sub-member 204a and a bottom sub-member 204b adjoined at (or proximate to) opposing edges 209 and 210 to form a support frame pocket 201 (see e.g., FIG. 2C). As alluded to above, a support frame of the presently disclosed technology may be slidably inserted into support frame pocket 201 such that top sub-member 204a and bottom sub-member 204b sandwich the support frame. In various examples, top sub-member 204a and bottom sub-member 204b may be adjoined via adhesive interface 207. As depicted, flaps 205 (which may comprise four flaps) may be adjoined/affixed to top member 204 at respective edges of top member 204 such that flaps 205 hang down/suspend from top member 204 to enclose a central region for placing food or liquid to be heated within a cooking appliance. As alluded to above, at least the cooking appliance door-facing flap of flaps 205 may be adjoined to bottom sub-member 204b to permit a support frame's insertion into support frame pocket 201. In various examples, bottom sub-member 204b and flaps 205 may comprise a continuous piece of material (e.g., a first piece of absorbent paper material). Accordingly, top sub-member 204a may comprise another piece of material (e.g., a second piece of absorbent paper material) that is adjoined to the continuous piece comprising bottom sub-member 204b and flaps 205 via adhesive interface 207. In certain examples, top sub-member 204a and two of flaps 205 (e.g., the two flaps facing the left and right surfaces of the cooking appliance) may comprise a first continuous piece of material. In these examples, bottom sub-member 204b and the other two flaps of flaps 205 (e.g., the flaps facing the cooking appliance door and the back of the cooking appliance respectively) may comprise a second continuous piece of material. In these examples, the first continuous piece of material may be adjoined to the second continuous piece of material via adhesive interface 207.

As depicted, splatter-reducing shroud 200 may also comprise a lift tab 202. Lift tab 202 may be located at a cooking appliance door-facing edge of top sub-member 204a. Pulling lift tab 202 can further open support frame pocket 201 to facilitate slidable insertion or removal of a support frame within support frame pocket opening 201.

After insertion of a support frame in support frame pocket 201, the support frame may be mechanically coupled to a magnetic member. When the magnetic member is magnetically coupled to an interior ceiling surface of a cooking appliance, splatter-reducing shroud 200 may then hang from the support frame such that splatter-reducing shroud 200 is suspended within the cooking appliance. As depicted, splatter-reducing shroud 200 may comprise one or more coupling component openings 203 that permit coupling component(s) of an inserted support frame to couple with coupling component(s) of magnetic member(s).

Flap opening 208 comprises a region where flaps 205 do not extend fully to a floor surface of the cooking appliance. Flap opening 208 may facilitate lifting of one of flaps 205 (e.g., a cooking appliance door-facing flap) and insertion or removal of food or beverage items by providing an area where an operator may grip the flap to pull the flap aside.

FIG. 2B illustrates an isometric view of a splatter-reducing shroud 200, highlighting how pieces of splatter-reducing shroud may be adjoined via adhesive interface 207. Adhesive interface 207 may comprise any adhesive type (e.g., natural, synthetic, inorganic). In some embodiments adhesive interface 207 may comprise an adhesive which does not interact with energy emitted during operation of a cooking appliance (e.g., non-ferrous adhesives, non-metallic adhesives).

FIG. 2C illustrates an isometric view of a splatter-reducing shroud, zoomed in to highlight support frame pocket 201. Support frame pocket 201 may have an opening approximately the same width as a support frame.

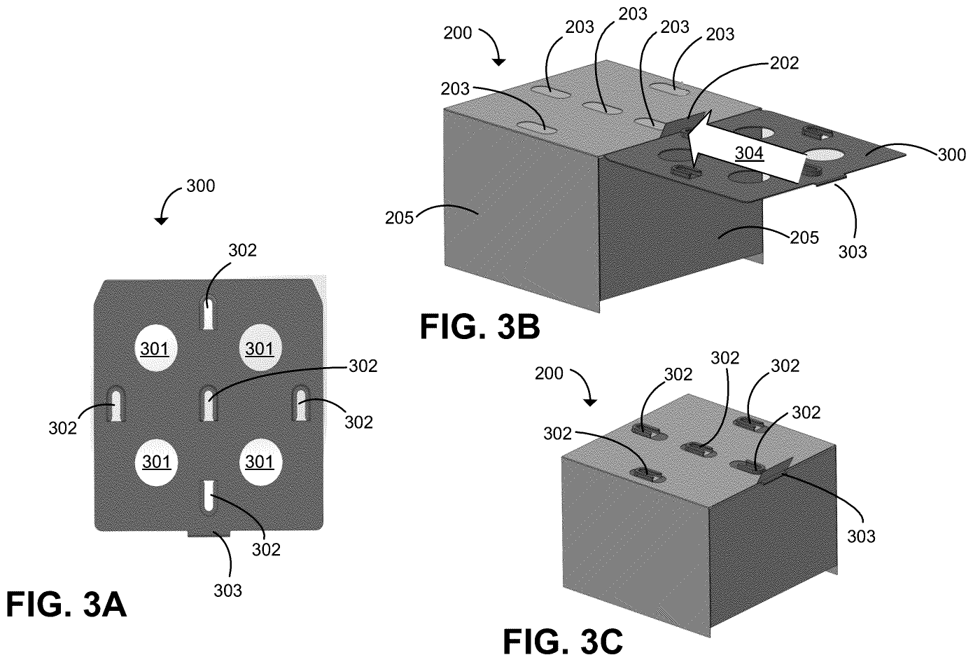

FIGS. 3A-C illustrate various aspects of an example support frame 300 inserted within a support frame pocket of a splatter-reducing shroud 200, in accordance with examples disclosed herein. Here, splatter-reducing shroud 200 may be the same splatter-reducing shroud depicted in conjunction with FIGS. 2A-C.

FIG. 3A illustrates an overhead view of support frame 300. As depicted, support frame 300 may comprise an approximately planar construction that is suspended approximately parallel to a cooking appliance floor during use.

Support frame 300 may comprise ventilation holes 301, coupling components 302, and gripping tab 303. Ventilation holes 301 may comprise holes in support frame 300 permitting air flow through support frame 300. In some examples, support frame 300 may comprise only one ventilation hole 301, any number of ventilation holes 301, or ventilation holes 301 may be omitted entirely. Support frame 300 may comprise a number, orientation, or placement of ventilation holes which corresponds with a ventilation system of a cooking appliance, such that obstruction of the ventilation system by the splatter-reducing device is mitigated. For instance, the disclosed arrangement of ventilation holes 301 may correspond with a cooking appliance ventilation system pushing or pulling air through a ceiling surface of the cooking appliance.

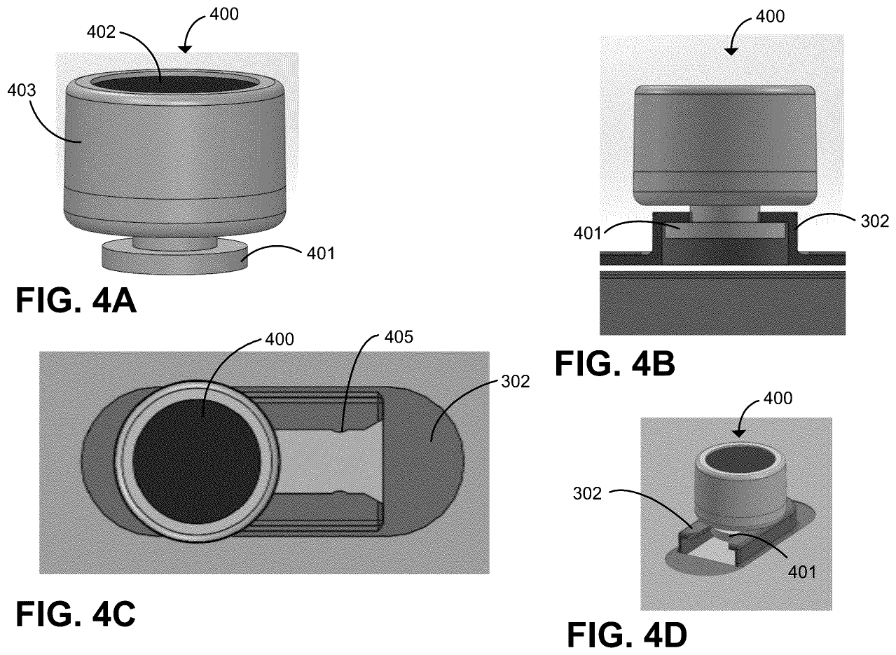

Coupling components 302 comprise slotted grooves fixed to the surface of support frame 300, wherein each slotted groove is shaped to guide a received flanged terminus of a magnetic member to a removably fixed position within the slotted groove. Magnetic members, slotted groove coupling components and flanged terminus coupling components are disclosed in more detail in relation to FIG. 4. Coupling components 302 may comprise any structure allowing removable fixation of the coupling component 302 with a reciprocal coupling component fixed to a magnetic member. Example coupling components 302 may include, e.g., a hook (e.g., for reciprocal coupling to another hook, a loop, a rod, etc.), a loop (e.g., for reciprocal coupling to a hook, a rod, etc.), a socket snap fastener (e.g., for reciprocal coupling to a stud snap fastener), a stud snap fastener (e.g., for reciprocal coupling to a socket snap fastener), etc.

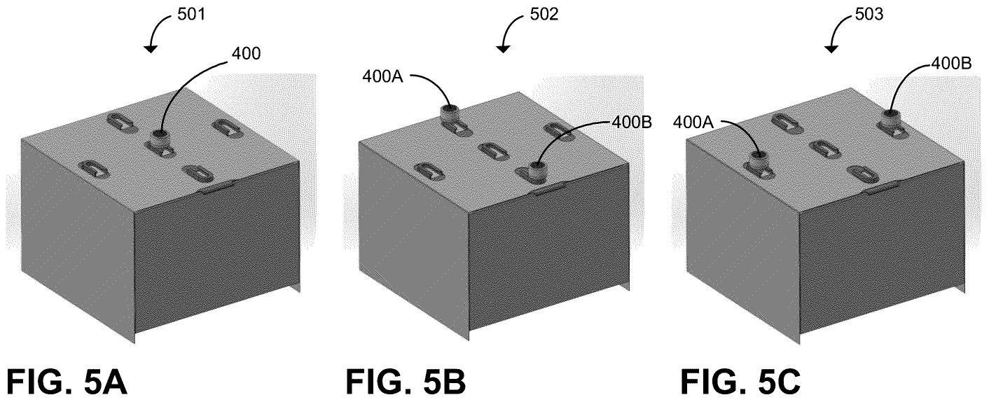

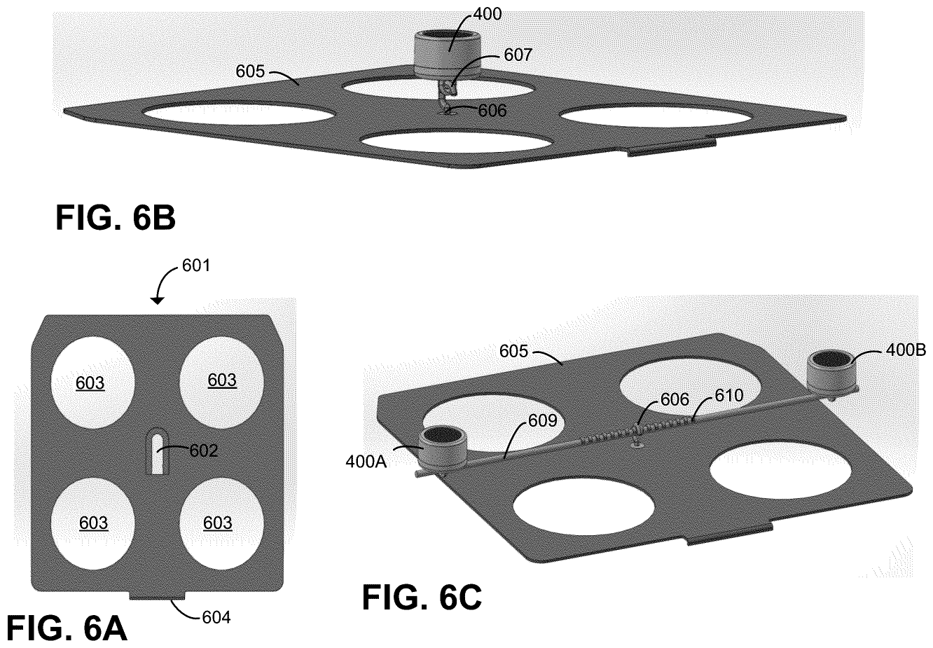

Support frame 300 may comprise a number, orientation, or placement of coupling components 302 which correspond with an interior ceiling surface of a cooking appliance. For instance, the disclosed arrangements of coupling components 302 may allow for removable fixation of coupling components 302 at opposite ends of the support frame 300 with reciprocal coupling components of similarly spaced magnetic members. In the disclosed arrangement, utilization of multiple coupling components 302 with multiple magnetic members may enable more stable suspension of a splatter-reducing device when the magnetic members are magnetically coupled to the interior ceiling surface of a cooking appliance. The disclosed arrangement of five coupling components 302, one at the center and four at the sides, may permit multiple configurations of magnetic members for supporting the splatter-reducing device within various different cooking appliances. Potential magnetic member configurations are disclosed further in relation to FIGS. 5-6. In some examples, support frame 300 may comprise one coupling component 302. In some examples, support frame 300 may comprise any number of coupling components 302.

Gripping tab 303 may comprise a ridged lip extending beyond one edge of support frame 300, wherein gripping tab 303 may be gripped by an operator of the splatter-reducing device to facilitate insertion or removal of support frame 300 from within a support frame pocket of a splatter-reducing shroud.

FIG. 3B illustrates insertion of a support frame 300 within a support frame pocket of splatter-reducing shroud 200 (described in more detail in conjunction with FIGS. 2A-C). An operator of the splatter-reducing device may grab gripping tab 303 on a proximal end of support frame 300, place the distal end of support frame 300 against the support frame pocket opening, widen the support frame pocket opening by pulling upward on the lift tab 202, and slide support frame 300 in the insertion direction 304 to insert support frame 300 into the support frame pocket of splatter-reducing shroud 200. Removal of support frame 300 from the support frame pocket may be achieved by pulling on the gripping tab 303 while holding the lift tab 202 stationary. These methods of insertion or removal of the support frame 300 are only exemplary, various means of inserting or removing support frame 200 from the support frame pocket may be employed. In the disclosed example, coupling component openings 203 are located on a top surface of splatter-reducing shroud 200, such that upon completed insertion of support frame 300 within the support frame pocket, the coupling component openings 203 align with the coupling components 302. The alignment of coupling components 302 with coupling component openings 203 may permit coupling between magnetic members and coupling components 302 despite support frame 300's insertion inside the support frame pocket.

FIG. 3C illustrates support frame 300 inserted within the support frame pocket. Gripping tab 303 may still be visible protruding through the support frame pocket opening, such that an operator may grab the gripping tab 303 to begin removing support frame 300 from the support frame pocket. Coupling components 302 may be seen protruding through the coupling component openings 203 of splatter-reducing shroud 200, such that reciprocal coupling components may couple with coupling components 302. Upon coupling between a coupling component 302 and a coupling component of a magnetic member, the magnetic member fixed may be magnetically coupled to the interior ceiling surface of a cooking appliance to suspend support frame 300 within the cooking appliance. When support frame 300 is within the support frame pocket of splatter-reducing shroud 200, splatter-reducing shroud 200, in turn, may be suspended within the cooking appliance. This suspended splatter-reducing shroud 200 may then deflect or absorb ejected food or beverage materials before it splatters on interior surfaces of the cooking appliance. The disclosed utilization of a support frame pocket may protect the food/beverage-facing surfaces of support frame 200 from splattered food and beverage materials. In some examples, splatter-reducing shroud 200 may be simplified to be a single piece of cloth or other light and flexible shrouding material, which rests on top of support frame 300 and hangs around the edges of support frame 300.

FIGS. 4A-D illustrate various aspects of an example magnetic member 400 and magnetic member 400's removable coupling to a support frame 300, in accordance with examples disclosed herein. Here, support frame 300 may be the same/similar support frame described in conjunction with FIGS. 3A-3C.

FIG. 4A illustrates an isometric view of the example magnetic member 400. Magnetic member 400 may comprise a coupling component 401, a magnet 402, and insulation 403. Coupling component 401 may comprise various types of structures allowing removable fixation/coupling with a coupling component fixed to a support frame. As depicted in the specific example of FIGS. 4A-C, coupling component 401 may comprise a flanged terminus that can be received within a slotted groove of a support frame. However, in other examples coupling component 401 may comprise e.g., a hook (e.g., for reciprocal coupling to another hook, a loop, a rod, etc.), a loop (e.g., for reciprocal coupling to a hook, a rod, etc.), a socket snap fastener (e.g., for reciprocal coupling to a stud snap fastener), a stud snap fastener (e.g., for reciprocal coupling to a socket snap fastener), etc.

Magnet 402 may comprise any type of magnet, e.g., permanent, temporary, electromagnet. Magnet 402 may provide the means with which magnetic member 400 is magnetically coupled to an interior ceiling surface of a cooking appliance, wherein the interior ceiling surface is magnetically active. For instance, magnet 402 may comprise a neodymium magnet which is attracted toward a ferrous interior ceiling surface of a cooking appliance when coupling component 401 is oriented away from the interior ceiling surface. In examples where a cooking appliance's interior ceiling surface is not magnetically active, magnetic member 400 may instead be a fixable member comprising a non-magnetic mechanism for mechanically coupling with the interior ceiling surface. For example, a fixable member may comprise a patch of adhesive material on a surface opposite the reciprocal coupling component, such that the fixable member may be adhesively joined to a stainless-steel interior ceiling surface of a cooking appliance. In such examples, the adhesive material may comprise an adhesive which does not interact with energy emitted during operation of a cooking appliance (e.g., non-ferrous, non-metallic adhesives).

Insulation 403 may comprise a magnetically insulating material, wherein the magnetically insulating material mitigates interactions of energy emitted during operation of the cooking appliance with magnet 402. In some examples, the magnetically insulating material may not cover a cooking appliance ceiling-facing surface of the magnet 402, such that magnet 402 may still be attracted to the interior ceiling surface of the cooking appliance. In some examples, insulation material may comprise any type of insulation (e.g., electrical, thermal, magnetic), or may comprise electromagnetic shielding. In some examples, the insulating material may comprise a composite of multiple different types of shielding or insulation. In some examples, insulation 403 may cover all surfaces of the magnet 402.

FIG. 4B illustrates a side view of an example magnetic member wherein coupling component 401 has been coupled to a coupling component 302 of support frame 300. The depicted coupling component 401 is a flanged terminus slid into a removably fixed position within coupling component 302, wherein coupling component 302 is a slotted groove. The edges of the flanged terminus of coupling component 401 overlap with the edges of the slotted groove coupling component 302 such that support frame 300 may hang from magnetic member 400. In some examples, other mechanical coupling mechanisms may be used. In some examples, the specific form of the coupling component 401 may be swapped with the specific form of coupling component 302, e.g., coupling component 401 may comprise a slotted groove and coupling component 302 may comprise a flanged terminus.

FIG. 4C illustrates an overhead view of magnetic member 400 coupled to coupling component 302 of support frame 300. In examples with a flanged terminus/slotted groove configuration, the slotted groove may comprise groove ridges 405, wherein groove ridges 405 prevent the flanged terminus from sliding back out of the slotted groove, absent some extra force exerted. The flanged terminus/slotted groove configuration may be said to “removably fix” or “removably couple” coupling component 401 with coupling component 302 because removal of the flanged terminus is still possible, but only with extra exertion of force (e.g., applied by an operator). Other mechanical coupling mechanisms may be used which also may removably fix/couple coupling component 401 with coupling component 302 of support frame 300, e.g., the extra force needed to undo snap fasteners, the extra force needed to lift a hook out of a loop, etc.

FIG. 4D Illustrates an isometric view of magnetic member 400, wherein coupling component 401 has been coupled to coupling component 302 of support frame 300. This view is disclosed to provide added perspective on how the working edges of a ridged edge/slotted groove configuration may overlap.

Coupling components may be described herein as fixed to an associated support frame or magnetic member. However, such descriptions should not be taken to imply that the coupling components or reciprocal coupling components are required to be separate material from the associated support frame or magnetic member. In some examples, coupling components or reciprocal coupling components may be a portion continuous with the associated support frame or magnetic member, e.g., a flanged terminus for coupling with a slotted groove may be formed by cutting away portions of a magnetic member.

FIGS. 5A-C illustrate various aspects of example magnetic members and the magnetic members' removable coupling to a support frame, in accordance with examples disclosed herein.

FIG. 5A discloses a center loaded configuration 501, wherein a single magnetic member 400 (which may be the same magnetic member as described in conjunction with FIGS. 4A-D) is mechanically coupled with the center of a support frame via one of the multiple coupling components fixed to the support frame. In the disclosed example, magnetic member 400 may be magnetically coupled to approximately the center of an interior ceiling surface of a cooking appliance in order to the suspend the splatter-reducing shroud over approximately the center of the cooking appliance's interior. The disclosed configuration may allow the splatter-reducing shroud to rotate around a vertical axis while suspended, or may allow magnetic member 400 to magnetically couple to a more accessible region of the cooking appliance's interior ceiling surface.

FIG. 5B discloses a front-back loaded configuration 503, wherein two magnetic members 400A-B are mechanically coupled to a support frame. Magnetic member 400A's coupling component is coupled with a rear coupling component of the support frame, while a magnetic member 400B's coupling component is coupled with a front coupling component of the support frame. In the disclosed example, magnetic member 400A may be magnetically coupled to approximately the rear of an interior ceiling surface of a cooking appliance, and magnetic member 400B may be magnetically coupled to approximately the front of an interior ceiling surface of the cooking appliance. The disclosed configuration may result in added stability in the forward-backward direction, or may allow the magnetic members 400A-B to magnetically couple to more accessible regions of the cooking appliance's interior ceiling surface.

FIG. 5C discloses a left-right loaded configuration 503, wherein the two magnetic members 400A-B are mechanically coupled to a support frame. Magnetic member 400A's coupling component is coupled with a left-side coupling component of the support frame, while magnetic member 400B's coupling component is coupled with a right-side coupling component of the support frame. In the disclosed example, magnetic member 400A may be magnetically coupled to approximately the left-side of an interior ceiling surface of a cooking appliance, and magnetic member 400B may be magnetically coupled to approximately the right-side of an interior ceiling surface of the cooking appliance. The disclosed configuration may result in added stability in the left-right axis, or may allow the magnetic members 400A-B to magnetically couple to more accessible regions of the cooking appliance's interior ceiling surface.

The disclosed magnetic member configurations 501-503 are only exemplary. Other configurations using magnetic members for any number of available coupling components may be used. For example, a configuration wherein five magnetic members are mechanically coupled to the support frame using the five available coupling components may be used to maximize stability of the support frame. In other examples, the support frame may comprise coupling components fixed to positions other than those illustrated herein, e.g., in a radial pattern, at the corners of the support frame, etc.

FIGS. 6A-C illustrate various coupling configurations of a splatter-reducing device, in accordance with examples disclosed herein. FIG. 6A illustrates an example support frame 601 wherein one coupling component 602, in the form of a slotted groove, is fixed to the center of the support frame 601. Support frame 601 also comprises ventilation holes 603 and a gripping tab 604, wherein ventilation holes 603 function analogously to the ventilation holes 301 and gripping tab 303 discussed in relation to FIG. 3A-C.

FIG. 6B illustrates a hook and loop-based coupling configuration using an example support frame 605. Support frame 605 comprises a hook-based coupling component 606 fixed to the center of support frame 605. Hook-based coupling component 606 may be removably fixed/coupled to a loop-based coupling component 607 of a magnetic member 400 (which may be the same magnetic member described in conjunction with FIGS. 4A-D and FIGS. 5A-C) by passing the hook end of hook-based coupling component 606 through the loop of loop-based coupling component 607. Loop-based coupling component 607 is coupled to magnetic member 400, which in turn may be magnetically fixed to an interior ceiling surface of a cooking appliance. The disclosed configuration may enable support frame 605 to be suspended from magnetic member 400 magnetically coupled to approximately the center of an interior ceiling surface of a cooking appliance. This configuration may be analogous to the center loaded configuration discussed in FIG. 5A, except that the hook and loop-based coupling disclosed herein may prevent rotation of the splatter-reducing shroud round the vertical axis.

FIG. 6C illustrates a hook and rod-based coupling configuration using the example support frame 605. Hook-based coupling component 606 is removably fixed/coupled to a rod member 609, which is in turn removably fixed/coupled to loop-based reciprocal coupling components of magnetic members 400A and 400B (which may be the same magnetic members described on conjunction with FIGS. 5A-C). Further, rod member 609 may comprise anti-sliding ridges 610, wherein anti-sliding ridges 610 prevent the hook-based coupling component 606 from sliding along the rod member 609. Magnetic members 400A-B may be magnetically coupled to the interior ceiling surface of a cooking appliance to suspend a splatter-reducing shroud within a cooking appliance interior. This configuration may be analogous to the front-back or left-right loaded configurations discussed in FIGS. 5B-C, in that the disclosed configuration also allows multiple magnetic members 400A-B to employed to suspend the support frame. Despite only having one coupling component 606, support frame 605 may still be supported by multiple magnetic members 400A-B through utilization of the disclosed hook and rod-based coupling configuration. This coupling configuration may be useful in certain scenarios, e.g., where only support frame 605 is available and the interior ceiling surface of a cooking appliance has no accessible or magnetically active regions near the center of the interior ceiling surface.

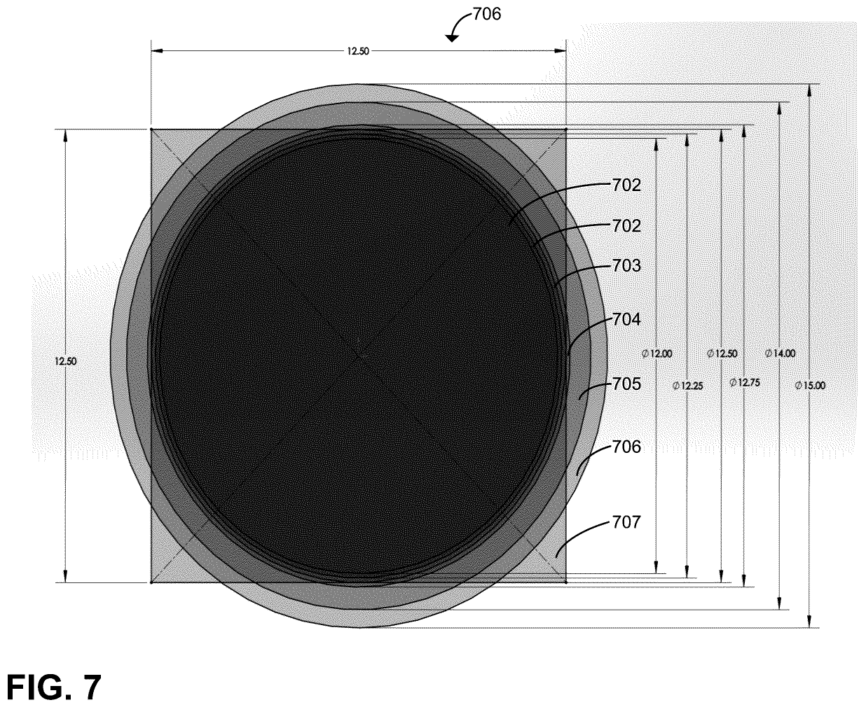

FIG. 7 illustrates several examples of splatter-reducing floorings 706 sizes and shapes. The illustration herein may be understood as a depiction of the sizes of several example splatter-reducing floorings 701-707, overlaid to show how they compare in size to each other. Circular splatter-reducing floorings 701-706 are various sized circular splatter-reducing floorings, wherein the radii of the splatter-reducing floorings 701-706 may vary to cover a wide range of turntable style cooking appliance interior ceiling-facing surfaces. Square splatter-reducing flooring 707 may be shaped as a square to match the bottom edges of a cube shaped splatter-reducing shroud. In some examples, splatter-reducing flooring 706 may be of a shape and size to match the bottom edges of a splatter-reducing shroud, such that the splatter-reducing shroud and flooring create a volume of space wherein cooking appliance interior surfaces on all sides are protected from splatter. In some examples, splatter-reducing flooring 706 may be of a shape and size to match a cooking appliance interior surface, e.g., the rectangular ceiling-facing surface on the bottom of a cooking appliance, a turntable surface on which food or beverages may be placed to rotate while cooking. Though the disclosed splatter-reducing floorings 701-707 are discussed as being circular when related to a turntable cooking appliance interior surface and square when relating to a splatter-reducing shroud, cooking appliance interior surfaces may be any shape (e.g., rectangular, square, circular). Further, the bottom edges of a splatter-reducing shroud may also form any shape (e.g., rectangular, square, circular).

Splatter-reducing flooring 706 may comprise approximately the same material comprising an associated splatter-reducing shroud. In some examples, splatter-reducing flooring 706 comprises a more robust material due to the possibility that splatter-reducing flooring 706 may need to physically support food or beverage items, or absorb spills flowing out of food or beverage items. In some examples, the splatter-reducing flooring 706 may be a separate component from the splatter-reducing device, intended to be implemented at the same time. In some examples, the splatter-reducing flooring 706 may be physically joined to a splatter-reducing shroud, such that the splatter-reducing flooring 706 and shroud may be removed and cleaned or replaced as a single item. In some examples, the splatter reducing flooring 706 may be omitted.

Splatter-reducing flooring 706 is depicted herein as transparent for purposes of illustrating how the various examples 701-707 may compare with each other in size. In some examples, splatter-reducing shroud flooring 706 may actually be transparent. In other examples, splatter-reducing shroud flooring 706 may have any opacity.

It should be understood that the various features, aspects and functionality described in one or more of the individual examples are not limited in their applicability to the particular example with which they are described. Instead, they can be applied, alone or in various combinations, to one or more other examples, whether or not such examples are described and whether or not such features are presented as being a part of a described example. Thus, the breadth and scope of the present application should not be limited by any of the above-described exemplary examples.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various examples set forth herein are described in terms of exemplary block diagrams, flow charts and other illustrations. As will become apparent to one of ordinary skill in the art after reading this document, the illustrated examples and their various alternatives can be implemented without confinement to the illustrated examples. For example, block diagrams and their accompanying description should not be construed as mandating a particular architecture or configuration.

What is claimed is:

1. A splatter-reducing device comprising:
a magnetic member magnetically coupled to an interior ceiling surface of a cooking appliance, the magnetic member comprising a magnet and a first coupling component affixed to a bottom surface of the magnet;
a support frame comprising a second coupling component removably coupled to the first coupling component such that the support frame is suspended within the cooking appliance; and
a shroud supported by the support frame and shaped to enclose a central region for placing food or liquid to be heated within the cooking appliance.

2. The splatter-reducing device of claim 1, wherein:
the first coupling component comprises a flanged terminus; and
the second coupling component comprises a slotted groove that receives the flanged terminus at a first end of the slotted groove and guides the flanged terminus to a removably fixed position at a second end of the slotted groove.

3. The splatter-reducing device of claim 1, wherein:
the first coupling component comprises a hook or a loop; and
the second coupling component comprises the other of the hook and loop.

4. The splatter-reducing device of claim 1, wherein the support frame comprises a planar support frame suspended within the cooking appliance approximately parallel to a floor surface of the cooking appliance.

5. The splatter-reducing device of claim 1, wherein the shroud is slidably coupled to the support frame and the shroud comprises:
a top member comprising a top sub-member and a bottom sub-member adjoined at two opposing edges to form a support frame pocket that sandwiches the support frame when the shroud is slidably coupled to the support frame; and
four flaps affixed to four respective edges of the top member such that the four flaps suspend from the bottom sub-member to enclose the central region for placing food or liquid to be heated within the cooking appliance.

6. The splatter-reducing device of claim 5, wherein the top sub-member comprises an opening that permits the removable coupling of the first coupling component and the second coupling component.

7. The splatter-reducing device of claim 5, wherein:
the top sub-member comprises a lift tab at a cooking appliance door-facing edge of the top sub-member; and
pulling the lift tab further opens the support frame pocket to facilitate slidable insertion or removal of the support frame within the support frame pocket.

8. The splatter-reducing device of claim 7, wherein:
the support frame comprises a gripping tab at a cooking appliance door-facing edge of the support frame; and
the gripping tab protrudes through an opening in the support frame pocket when the support frame has been inserted within the support frame pocket.

9. The splatter-reducing device of claim 1, wherein the second coupling component is located at a central region of a top surface of the support frame.

10. The splatter-reducing device of claim 1, wherein:
the splatter-reducing device further comprises a second magnetic member magnetically coupled to the interior ceiling surface of the cooking appliance, the second magnetic member comprising a second magnet and a third coupling component affixed to a bottom surface of the second magnet; and
the support frame comprises a fourth coupling component removably coupled to the third coupling component.

11. The splatter-reducing device of claim 1, wherein the support frame comprises a ventilation hole.

12. The splatter-reducing device of claim 1, wherein the shroud comprises an absorbent paper material.

13. The splatter-reducing device of claim 1, wherein the support frame comprises a plastic material.

14. A splatter-reducing device comprising:
a first magnetic member magnetically coupled to an interior ceiling surface of a cooking appliance, the magnetic member comprising a first magnet and a first loop affixed to a bottom surface of the first magnet;
a second magnetic member magnetically coupled to the interior ceiling surface of the cooking appliance, the second magnetic member comprising a second magnet and a second loop affixed to a bottom surface of the second magnet;
a rod removably positioned through the first loop and the second loop such that the rod is supported by the first and the second loop;
a support frame comprising a hook affixed to a top surface of the support frame, wherein the hook removably couples to the rod such that the support frame suspends below the rod; and
a shroud supported by the support frame and shaped to enclose a central region for placing food or liquid to be heated within the cooking appliance.

15. The splatter-reducing device of claim 14, wherein the rod comprises anti-sliding ridges that inhibit the hook from sliding along the rod.

16. The splatter-reducing device of claim 14, wherein the shroud comprises an absorbent paper material.

17. The splatter-reducing device of claim 14, wherein the support frame comprises a plastic material.

18. A device comprising:
a fixable member comprising an adhesive patch and a first coupling component, the adhesive patch removably coupling the fixable member to an interior ceiling surface of a cooking appliance;
a support frame comprising a second coupling component removably coupled to the first coupling component such that the support frame is suspended within the cooking appliance; and
a shroud supported by the support frame and shaped to enclose a central region for placing food or liquid to be heated within the cooking appliance.

19. The device of claim 18, wherein the shroud comprises an absorbent paper material.

20. The device of claim 18, wherein the support frame comprises a plastic material.
